(19) United States
(12) Patent Application Publication
(10) Pub. No.: US 2026/0220170 A1
(43) Pub. Date: Jul. 30, 2026

(54) INFORMATION GENERATION METHOD AND APPARATUS, AND ELECTRONIC DEVICE

(71) Applicant: Lenovo (Beijing) Limited, Beijing (CN)

(72) Inventor: Yonghua HU, Beijing (CN)

(21) Appl. No.: 19/455,236

(22) Filed: Jan. 21, 2026

(30) Foreign Application Priority Data
Jan. 26, 2025 (CN) 202510123957.3

(51) Int. Cl. G06F 16/3329; G06F 16/335; G06F 16/353

(52) U.S. Cl. CPC G06F 16/3329; G06F 16/335; G06F 16/353

(57) ABSTRACT

An information generation method includes obtaining input information for provision to a target model, and obtaining a target prompt representing a target identity. The target prompt is not part of the input information and is used to guide processing of the target model. The method further includes guiding the target model to process the input information based at least on the target prompt to generate output information.

### CROSS-REFERENCE TO RELATED APPLICATION

This application claims priority to Chinese Patent Application No. 202510123957.3, filed on January 26, 2025, the entire content of which is incorporated herein by reference.

### TECHNICAL FIELD

The present disclosure generally relates to the field of artificial intelligence, and, more particularly, to an information generation method and apparatus, and an electronic device.

### BACKGROUND

With the rapid development of artificial intelligence, large language models (LLMs) are pre-trained on web data (i.e., data from publicly available web searches). When users chat with an LLM, the LLM finds relevant answers based on the information from public web pages. The users need to input accurate descriptive characters or clearly defined requirement characters as prompts, or they need to accurately describe the characters or clearly define the requirements again as prompts in subsequent rounds of dialogue based on each response to further guide the LLM, to obtain the desired answer. This approach, which typically relies on the users frequently inputting prompts or guiding the LLM through multiple rounds of interactions, not only increases the users’ burden but also lacks adaptability to dynamic scenarios.

### SUMMARY

In accordance with the disclosure, there is provided an information generation method including obtaining input information for provision to a target model, and obtaining a target prompt representing a target identity. The target prompt is not part of the input information and is used to guide processing of the target model. The method further includes guiding the target model to process the input information based at least on the target prompt to generate output information.

Also in accordance with the disclosure, there is provided an electronic device including an input apparatus configured to receive input information for provision to a target model, and a processor configured to obtain a target prompt representing a target identity. The target prompt is not part of the input information and is used to guide processing of the target model. The processor is further configured to guide the target model to process the input information based at least on the target prompt to generate output information.

Also in accordance with the disclosure, there is provided a non-transitory computer-readable storage medium storing instructions that, when executed by a processor, cause an electronic device including the processor to obtain input information for provision to a target model, and obtain a target prompt representing a target identity. The target prompt is not part of the input information and is used to guide processing of the target model. The instructions further cause the electronic device to guide the target model to process the input information based at least on the target prompt to generate output information.

### BRIEF DESCRIPTION OF THE DRAWINGS

FIG. 1 is a flow chart of an information generation method consistent with embodiments of the present disclosure.

FIG. 2 is a schematic diagram of a dialogue in an information generation method consistent with embodiments of the present disclosure.

FIG. 3 is a flow chart showing obtaining target prompts in an information processing method consistent with embodiments of the present disclosure.

FIG. 4 is another flow chart showing obtaining target prompts in an information processing method consistent with embodiments of the present disclosure.

FIG. 5 is another flow chart showing obtaining target prompts in an information processing method consistent with embodiments of the present disclosure.

FIG. 6 is another flow chart showing obtaining target prompts in an information processing method consistent with embodiments of the present disclosure.

FIG. 7 is a flow chart showing obtaining dialogue contents in an information processing method consistent with embodiments of the present disclosure.

FIG. 8 is a flow chart of another information generation method consistent with embodiments of the present disclosure.

FIG. 9 is a schematic structural diagram of an information generation apparatus consistent with embodiments of the present disclosure.

FIG. 10 is a schematic structural diagram of an electronic device consistent with embodiments of the present disclosure.

### DETAILED DESCRIPTION OF THE EMBODIMENTS

Various schemes and features of the present disclosure are described herein with reference to the accompanying drawings. The descriptions are only used to explain the specific embodiments of the present disclosure and are not intended to limit the scope of the present disclosure. It is understandable to those skilled in the art that with the development of technology and the emergence of new scenarios, the technical solutions provided in the embodiments of the present disclosure are also applicable to similar technical problems.

The terms used in the present disclosure are only for the purpose of description and are not intended to limit the scope of the present disclosure. The terms “including,” “comprising,” and any variations thereof, are intended to indicate the existence of described features, steps, operations, or components, but do not exclude the presence of or addition of one or more other features, steps, operations, or components.

Unless otherwise defined, all technical and scientific terms used in the present disclosure have the same meaning as those generally understood by those skilled in the art. The terminology used herein should be interpreted in a manner consistent with the context of the present disclosure, and should not be interpreted in an idealized or overly rigid manner.

In cases where expressions similar to “at least one of A, B, and C” or “at least one of A, B, or C” are used, the expression should generally be interpreted according to the meaning commonly understood by those skilled in the art (for example, a system having at least one of A, B, and C (or a system having at least one of A, B, or C) should include, but is not limited to, a systems having only A, only B, only C, A and B, A and C, B and C, and/or A, B, and C).

In the embodiments of the present disclosure, the collection, updating, analysis, processing, use, transmission, provision, disclosure, or storage of data involved (including but not limited to user personal information) comply with relevant laws and regulations, are used for legitimate purposes, and do not violate public order and good morals. In particular, necessary measures are taken to prevent unauthorized access to user personal information data, and to maintain the security of user personal information, network security, and national security.

A target model involved in the present disclosure is a machine learning model that can identify natural language and/or other inputs (such as audio, video, images, tables, etc.) input to the target model, and perform comprehensive language processing tasks such as semantic analysis or question answering, thereby generating output related to the input and/or responding to the input.

The target model involved in the present disclosure learns characteristics and patterns of natural language by training on a large amount of diverse data, thus enabling it to understand and generate natural language. It typically has hundreds of millions to hundreds of billions of model parameters (model parameters are variables that control the behavior of the target model), capable of capturing complex relationships and patterns in natural language.

The target model involved in the present disclosure may be a generative model or a generative language model (GLM). For example, it may specifically include large language models (LLMs), GPT (Generative Pre-trained Transformer), etc. The model involved in the embodiments of the present disclosure may be a general large model, or an expert large model obtained after fine-tuning based on requirements, which is not limited in the present disclosure.

For example, the large language model (LLM) may be a machine learning model, based on deep neural network architectures such as the Transformer, that has been trained on large-scale corpora of natural language data. An LLM contains a very high number of parameters, e.g., in the order of billions or more, which enables LLM to capture statistical patterns, semantic relationships, and/or contextual dependencies in human language. The LLM can perform tasks including, but not limited to: natural language understanding (e.g., intent recognition, information extraction), natural language generation (e.g., text completion, summarization, dialogue response), reasoning and decision support, code generation, and multi-modal integration (in some cases). LLMs may operate by processing input sequences of tokens (text units) and predicting subsequent tokens in context, which allows them to generate coherent, contextually appropriate text. The large parameter size and training data scale distinguish LLMs from conventional language models, providing broader generalization and adaptability across domains without task-specific training. In practical use, model parameters of the LLM may be stored in a memory, and the LLM may be loaded into a runtime environment and executed by at least one processor of an electronic device to perform an inference process. During execution, the processor may invoke the LLM in response to an input instruction, and input data may be obtained via an input unit and provided to the LLM, while output data generated by the LLM may be transmitted to, e.g., a display unit and/or a communication module, so that the LLM cooperates with the hardware system of the electronic device to implement desired processes.

In the embodiments of the present disclosure, user authorization or consent is obtained before acquiring or collecting user personal information.

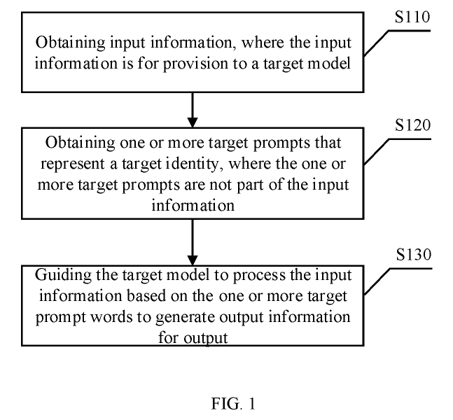

The present disclosure provides an information generation method. FIG. 1is a flow chart of an information generation method according to an embodiment of the present disclosure.

As shown in FIG. 1, in one embodiment, the information generation method includes S110 to S130.

At S110, input information is obtained, where the input information is for provision to a target model.

The input information may be content provided to the target model through an information transmission device or interactive interface (e.g., input by a user), and may be used to trigger the target model to perform a specific task or generate a corresponding output result. The input information may include text, voice, or other forms of content, and may be used to provide the target model with information to understand a user’s intent and clarify the user’s needs or questions. The content of the input information may be specific instructions, questions, descriptions, or even vague requests.

The input information may include one or more first prompts, which are used to guide the processing of the target model. For example, the first prompts may be suggestive content embedded in the input information, used to directly guide the target model to perform a specific task or adjust its generation behavior. The first prompts may be explicitly provided by the user and transmitted to the target model along with the input information, and may be used to enable the model to understand the user’s intent and thus complete the task more accurately.

For example, the first prompts may be task-oriented prompts, used to clearly specify the task objective and tell the model how to process the input information or the expected output content format. For example, the input information may be “Summarize the following article content in concise language . . .,” where the first prompts may include “Summarize in concise language.”

As another example, the first prompts may be output format-oriented prompts, used to specify the form or structure of the output result and help the model adjust the format of the generated content. For example, the input information may be “List the comparison of the following data in a table . . .,” where the first prompts may be “List in a table format.”

As another example, the first prompts may be constraint-oriented prompts, used to set specific constraints or rules to restrict the scope or style of the content generated by the model. For example, the input information may be “Answer the following question using no more than 50 words . . .,” where the first prompts may be “Answer using no more than 50 words.”

The input information may not include the first prompts. The input information may only include a task description or request, without explicitly specifying the processing method, role setting, or output requirements of the target model. The description of the input content may be implicit and vague, which may not directly guide the model’s behavior through prompts.

For example, the input information may be a vague request, without explicitly stating the specific task, which only gives simple operation instructions. For example, the input information may be “Summarize today’s conversation,” where the output format, role, or other constraints are not explicitly specified. As another example, the input information may be a general question which does not include prompt information to guide the model, and the model may process the information according to default rules or target keywords. For example, the input information may be “What’s the weather like?” where the input content does not explicitly define the role or the output format. As another example, the input information may be a brief description that only describes the subject or object of the task, without including specific task objectives or processing instructions. For example, the input information may be “Explain quantum computing,” without specifying whether a detailed explanation, a concise summary, or other specific requirements are needed.

S120, one or more target prompts used to characterize the target model’s identity are obtained. The one or more target prompts are not part of the input information, and are used to guide the processing of the target model.

The target prompts may be a type of prompt information distinct from the first prompts, and may be used to adjust and guide how the target model processes tasks, characterize the target model’s identity, behavior, or output style in the task, thereby optimizing the model’s task processing logic and generation method.

The target prompts may not depend on the input content, and may be information generated by the system, provided externally, or dynamically inferred, which is independent of user input. In contrast, the first prompts may be directly provided by the user or directly obtained from the input content, usually accompanying the task description.

The target prompts may specify the target model’s role or identity characteristics when performing a task, influencing the model’s language style, behavior, or task processing methods. For example, the target prompts may assign a specific role to the model, enabling its output to conform to the characteristics of the role and the task requirements, such as answering technical questions with professional terminology, explaining knowledge points in a teaching tone, or resolving user problems with a customer service tone. This characterization may allow the target model to better adapt to the needs of specific scenarios, providing the user with more contextually appropriate feedback. By setting the role or identity for the model, the target prompts may enhance the model’s adaptability to different tasks or scenarios.

For example, the target prompts may be role characteristic prompts, assigning a specific role to the model such that the model processes the task from the perspective of that role, such as a lawyer role, a doctor role, a teacher role, etc. The target prompts may also be style or tone prompts, influencing the style or tone of the model’s language output. For example, the style or tone may include rigorous, humorous, concise, etc. The target prompts may also be environmental prompts, influencing the scope of the model’s generated output to adapt to a specific context. For example, the target prompts may be “in a restaurant.”

There may be one or more target prompts. When there are multiple target prompts, the target model’s processing may be simultaneously guided by the multiple target prompts, and the generated output information may match the identity represented by each target prompt. For example, the target model may generate output content in a doctor’s role and simultaneously with a humorous style.

At S130, based on the one or more target prompts, the target model is guided to process the input information and generate output information.

When generating the output information, the target model may be constrained or guided by the target prompts, ensuring that the generated output information conforms to specific roles, styles, or requirements.

In one embodiment, the target prompts may be role characteristic prompts. For example, when the target prompts include “lawyer role,” the model may provide clear and concise legal explanations from a lawyer role’s perspective; when the target prompts include “customer service,” the model may generate information using standard customer service procedures, providing user-friendly guidance.

In one embodiment, the target prompts may include style and tone prompts. For example, when the target prompts include “humorous style,” the model may generate the output information in a lighthearted and entertaining language; or when the target prompts include “concise style,” the generated output information may be shorter, avoiding lengthy explanations.

In one embodiment, the target prompts may include environmental prompts. For example, when the scenario is that the device is in a low power mode and the target prompts includes “Low battery,” the model may generate the output information in a concise form, avoiding the generation of images, audio, or other content that consumes a lot of power; or, when the scenario is that the user is driving and the target prompts include “driving,” the model may generate voice-based output information to avoid safety hazards caused by the user’s attention being diverted.

In the present disclosure, since the target prompts are not input by the user but are automatically generated by the system, a more efficient user interaction experience may be achieved, simplifying operation steps and significantly improving the system’s convenience, especially in complex task scenarios. Also, the target prompts may be dynamically generated by the system, allowing for flexible adaptation to different scenarios, enhancing the system’s adaptability to dynamic situations, and enabling the model to provide optimized output results in different tasks or environments. Further, the target prompts may dynamically optimize the model’s processing method during task execution, improving the quality and efficiency of information generation, avoiding redundant information or style mismatches, and further enhancing the user experience.

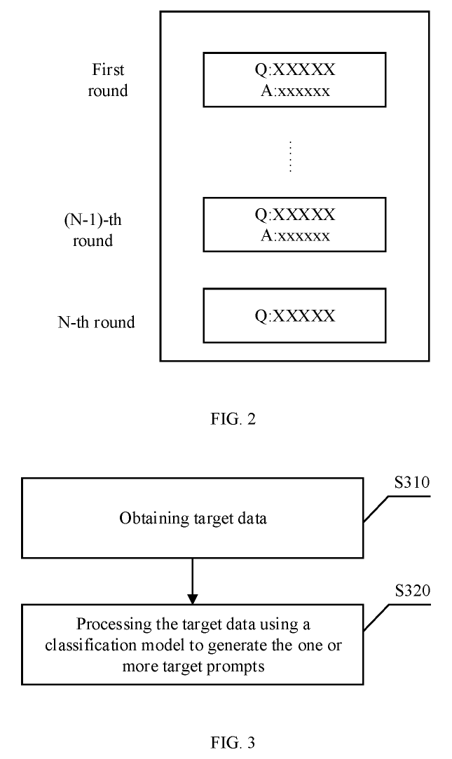

FIG. 2 schematically shows the input information in the information processing method according to an embodiment of the present disclosure.

In one embodiment of the present disclosure, the input information may be input information of the N-th round in a dialogue based on the target model, where N is an integer larger than or equal to 2. The output information of the (N-1)-th round prior to the input information may be the output information generated by the target model based on prompts representing a first identity (also referred to as an “existing identity”). The target identity may be different from the first identity.

One round may be the correspondence between input and output information included in one interaction loop during a dialogue between the user and the target model. For example, one round may be the target model’s processing mechanism triggered by user input information. The target model may generate the output information based on the current input information, context information, and system-generated prompts, thus completing one round of interaction.

A dialogue may be a series of continuous interactive operations between the user and the target model based on preset interaction logic, and may typically include a plurality of rounds of input and output information. A dialogue may take various forms such as text, voice, or images, and the input information may trigger the target model’s processing mechanism to generate corresponding output information. At least some of the plurality of rounds in the dialogue may have logical continuity, and subsequent input information may be related to or expanded upon the output information of previous rounds. For example, a dialogue may be an interaction process within a specific time period. As another example, a dialogue may be an interaction process including a specific number of rounds of input and output information. As another example, a dialogue may be an interaction process centered around a single task theme. As shown in FIG. 2, in one example, a dialogue may include N rounds, where each completed round includes input information Q: XXXXXX, and model output information A: xxxxxx. The N-th round may be an incomplete round, only including the input information Q: XXXXXX.

The input information may be the input information of the N-th round. Before processing the input information of the N-th round, the target model may already complete N-1 rounds of interaction, and the output information of the (N-1)-th round may be the output information generated based on the prompts representing the first identity.

In the N-1 rounds of interaction completed within a dialogue, the model may or may not have undergone an identity change. In the final (N-1)-th round of dialogue, the model may generate output information based on the prompts representing its first identity, while the target identity may be different from the first identity. In other words, the model may or may not have undergone an identity change in the first N-1 rounds, but at the start of the N-th round, the model’s identity may be different from the previous round.

In one dialogue, the target prompts may be generated for each round. That is, whenever the target model receives the input information for a new round, the system may regenerate the target prompts to represent the target identity. The target prompts may point to an identity different from or the same as the previous round. The target model may adjust its processing logic based on the target prompts to generate the output information that meets the requirements of the current round.

For example, in a dialogue, in the first round, the user inputs “Please tell me today’s weather.” The system generates the target prompts “As a weather forecaster,” indicating the target identity is a weather forecaster, and the model outputs “It will rain lightly today.” In the second round, the user inputs “What about tomorrow?”, the system generates the target prompts “As a weather forecaster,” indicating the target identity is a weather forecaster, and the model outputs “Tomorrow will be sunny.” In the third round, the user inputs “Is this weather suitable for hiking?”, the system generates the target prompts “As an outdoor sports expert,” indicating the target identity is an outdoor sports expert, and the model outputs “This weather is suitable for hiking, but it is recommended to take precautions against sunburn and carry enough water.”

It can be seen that in this dialogue, the target prompts are regenerated in each round to guide the model’s output. In the second round, the generated target prompts indicate the target identity as “weather forecaster” which is the same identity indicated by the prompts used to generate the output in the previous round (the first round). In the third round, the generated target prompts represent the target identity as “Outdoor Sports Expert,” which differs from the identity represented by the prompts (weather forecaster) used to generate the output information in the previous round (the second round).

In one dialogue, the target prompts may not be generated in every round, but rather only when certain triggering conditions are met. The triggering conditions may include, but are not limited to, input information exceeding the current identity range, a change in user intent, the dialogue time reaching a preset time threshold, dialogue length reaching a preset threshold, changes in external factors, or fulfillment of one or more specific rules.

When the input information exceeds the current identity range, i.e., when the first identity does not match the input information, the generation of the target prompts may be triggered. When the user’s input content exceeds the current identity range, or involves a new domain or task, and the first identity cannot meet the user’s needs, the new target prompts may be generated to adjust the identity. For example, when the first identity is “climatologist” and the model answers a question about global warming, if the user’s input is “What impact does this climate change have on the economy?”, the model detects that the question relates to the economic field, which doesn’t match the “climatologist” identity. Therefore, generating output as a “climatologist” is inappropriate, triggering the generation of the target prompts to change the identity to “economist.”

A change in user intent, meaning a shift in the intent or inclination represented by the user’s input, may also trigger the generation of the target prompts. In this case, the first identity may still be able to answer the user’s intent, but regenerating the target prompts to change the identity may be more appropriate. For example, in the previous round, the user input “How can I improve indoor air quality?”, with the user intent being to obtain general advice on improving indoor air quality. The first identity is an environmental expert, and the model output is “To improve indoor air quality, you can ventilate regularly, use an air purifier, reduce indoor pollution sources, etc.” In the current round, the user inputs “What is the technical principle of an air purifier?”, indicating that the user’s intention shifts from a general question about improving air quality to a deeper understanding of the technical principles of air purifiers, and to ask more professional technical questions. Although the first identity (environmental expert) is able to answer the user’s question, its answer may be too brief or general and cannot go into technical details. This may trigger the generation of the target prompts to switch to the target identity “technical expert,” making the model output more professional.

When the dialogue duration reaches a preset time threshold, that is, when the duration of the dialogue from the first round reaches a preset threshold, the generation of the target prompts may be triggered. For example, when the previous round occurred Monday, and the next round, i.e., the current round, is triggered Wednesday, a considerable amount of time has passed. The initial identity used in the previous round may not meet the user’s needs at the current moment, thus triggering the generation of the target prompts to ensure that the output of the model in the current round meets the user’s needs.

When the dialogue length reaches a preset threshold, that is, when the number of rounds in the dialogue reaches a preset length threshold, or when the amount of data included in the dialogue reaches a preset threshold, the generation of the target prompts may be triggered. As the dialogue length increases, the user’s needs may gradually become more diverse or complex, and the initial identity may not be able to fully cover the new needs, thus triggering the generation of the target prompt. For example, the generation of the target prompts may be triggered once every 10 rounds of dialogue.

Changes in external factors may include, but are not limited to, changes in the spatial environment, changes in the temporal environment, changes in the electronic devices used, changes in device status, changes in user preference settings, or changes in the user’s emotional tendencies. For example, when the user’s location changes from a residential area to a restaurant, the target prompts may be generated to change the target identity to “food expert,” making it easier to provide the user with more dining suggestions. As another example, when the user’s location changes to an office, the target prompts may be generated to change the target identity to “work assistant,” making the model’s output more concise, efficient, and work-related. As another example, when the user’s mood changes to pessimistic, the target prompts may be generated to change the target identity to “humorous and witty person,” allowing the model to respond to the user in a more positive and relaxed way. As another example, when the user wears and connects Bluetooth headphones, changing the electronic devices they are using, the target prompts may be generated to change the target identity to “voice assistant,” allowing the model to output information in the form of voice. As another example, when the user’s phone switches from a normal mode to a game mode, the target prompts may be generated to change the target identity to “game assistant,” and so on.

Meeting specific rules may include that part of the input information meets pre-defined rules. For example, it’s preset that the model’s identity needs to be changed to "Writing Assistant” when a user inputs “123” as the beginning of the input. Then, when the user inputs “123 I've been a little troubled lately,” the system detects that the input begins with “123,” triggering the generation of the target prompts to change the target identity to “Writing Assistant” and generating the output information “You mentioned you've been a little troubled lately. I can help you organize your thoughts or assist you in writing an article related to your feelings.” As another example, the model’s “Normal Mode” is pre-set to only include “Family Assistant” and “Work Assistant,” while the model’s “Advanced Mode” includes multiple identities such as “Family Assistant,” “Work Assistant,” “Legal Advisor,” or “Technical Expert.” Then, when the user prompts a change from “Normal Mode” to “Advanced Mode,” the generation of the target prompts may be triggered to redetermine the target identity.

In one embodiment, identity switching may be completed within the same dialogue. The continuity and contextual relevance of these identity switching may enable the target model to more accurately understand user intent and provide a coherent interactive experience. Since the generation of the target prompts may be controlled by triggering conditions, the intelligence of the dialogue may be enhanced, allowing the target model to flexibly adjust its identity when necessary, avoiding interference from unnecessary identity switching, ensuring that identity switching occurs at appropriate times, improving the relevance and accuracy of responses.

In some other embodiments, the input information may be input information of the first round in the target model’s dialogue. That is, when a dialogue begins, the generation of the target prompts may be triggered, giving the model an initial identity when conversing with the user, and the target prompts may not be part of the user’s input information.

FIG. 3 is a flowchart of obtaining the target prompts in an information processing method according to an embodiment of the present disclosure.

As shown in FIG. 3, in one embodiment, S120 may include S310-S320.

At S310, target data is obtained.

At S320, the target data is processed using a classification model to generate the one or more target prompts.

The target data may be data from various sources used to generate the target prompts, which is key information that directly affects system identity switching and behavior adjustment. The target data may be analyzed and classified using a classification model to generate the target prompts to guide the processing of the target model. In one embodiment, the target data may undergo preprocessing, including but not limited to text segmentation, sentiment analysis, or data normalization. For different types of target data, the system may extract feature information, such as identity, location, time, intent, or state features, and then generate feature vectors. The classification model may map the feature vectors to different category labels, with different category labels corresponding to different target identities, output methods, or ranges, thereby generating at least one target prompt based on the category labels.

The classification model may be a pre-trained machine learning model used to assign input data to one or more predefined categories or labels, that is, to classify the data such that each data point belongs to a specific category. The model may be trained using labeled data (i.e., each input data already has a corresponding category label) and may be able to then predict and classify new, unlabeled data.

The algorithms or architectures used in the classification model may include one or more of logistic regression, decision trees, support vector machines, K-nearest neighbors, random forests, or neural networks. Those skilled in the art may choose appropriate algorithms or architectures to design the classification model according to actual conditions, which is not limited in the present disclosure.

S320 may further include: processing the target data and historical data through the classification model to generate the one or more target prompts. The historical data (such as user’s historical behavior, interaction records, etc.) may be used as input features of the classification model. That is, the historical data may be processed into feature vectors and used as one of the inputs, along with the feature vectors formed by the target data, and input into the classification model to generate the prompt.

S320 may further include: processing the target data through the classification model and a knowledge graph to generate the one or more target prompts. The knowledge graph may include entities, relationships, or contextual information. The entity relationships or contextual information in the knowledge graph may serve as input to a classification model. With the support of embedding techniques or graph neural networks, the graph information, along with other input features, may be fed into the classification model to generate the target prompts. For example, the knowledge graph may provide “patient symptoms-diagnosis-treatment” association information, and the classification model may generate the target prompts “medical consultation assistant” based on these features.

According to embodiments of the present disclosure, the classification model may have powerful data learning capabilities. The classification model may dynamically adjust the generation of the prompts in different interaction scenarios, and automatically identify the prompts that best match the target identity or scenario, thereby achieving efficient and accurate prompt generation. The flexibility and personalized service capabilities of the target model in complex environments may be improved, better adapting to the needs of different users and scenarios.

In the present disclosure, the classification information output by the classification model may serve as identity-representing prompts. The classification information may influence the identity of the target model (LLM) when answering and the use of the corresponding Personal Knowledge Base (PKB) to respond. In one embodiment, when the target model answers based on network data, the prompts representing the target identity, which is represented by the classification information, answering with the target identity may be more focused. In another embodiment, the output classification information of the classification model may also be used to determine the corresponding Personal Knowledge Base (PKB), making the response result of the target model (LLM) based on data in the corresponding PKB more focused. The classification model provided in the present disclosure may make the response result more focused and effective.

In some other embodiments, the target prompts may be generated according to preset rules, such as matching specific features. For example, keywords, sentence structures, or fixed patterns, may generate target prompts. For example, when the target data includes “weather” related content, the prompts related to the identity of “weather assistant” may be generated. Through feature matching, when the dialogue between the user and the target model is concise and clear, rapid matching may be achieved with less resource consumption and faster speed.

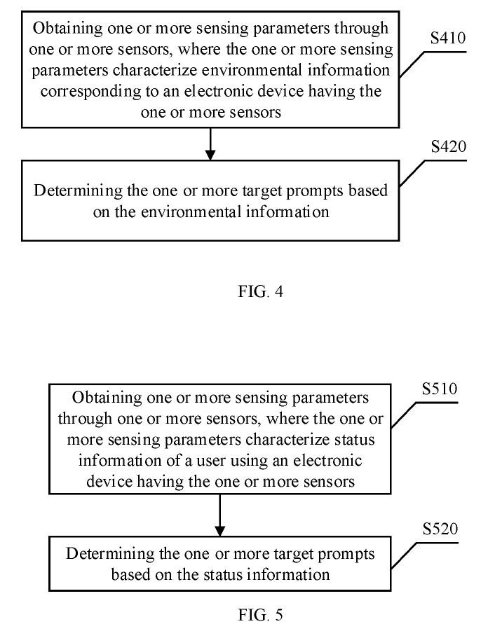

FIG. 4 is another flowchart of obtaining target prompts in the information generation method according to another embodiment of the present disclosure.

As shown in FIG. 4, in another embodiment, S120 may include S410-S420.

At S410, one or more sensing parameters are acquired by one or more sensors, which are used to characterize environmental information corresponding to the electronic device having the one or more sensors.

The sensing parameters may be acquired by a sensor built into the electronic device, and/or by a sensor capable of connecting and communicating with the electronic device, and/or by a sensor in another electronic device capable of connecting and communicating with the electronic device. The sensor may include, but is not limited to, one or more of temperature sensor, humidity sensor, pressure sensor, accelerometer sensor, gyroscope sensor, light sensor, gas sensor, sound sensor, heart rate sensor, skin conductance sensor, touch sensor, infrared sensor, magnetometer sensor, position sensor, barcode scanner, biometric sensor, motion sensor, environmental noise sensor, air quality sensor, barometric pressure sensor, radar sensor, vibration sensor, rotation sensor, thermocouple sensor, ultraviolet sensor, current sensor, ultrasonic sensor, or chemical sensor. The sensing parameters may be data collected by the sensor that reflect or describe the physical, chemical, or environmental characteristics of the environment in which the device is located. These parameters may include, but are not limited to, one or more of: gas concentration parameters, magnetic field strength parameters, vibration frequency parameters, acceleration parameters, rotational angular velocity parameters, displacement parameters, distance parameters, depth parameters, touch pressure parameters, current parameters, voltage parameters, resistance parameters, electromagnetic radiation parameters, radio frequency signal strength parameters, heat parameters, heart rate parameters, blood oxygen saturation parameters, skin resistance parameters, respiratory rate parameters, electromyographic signal parameters, bioelectrical signal parameters, motion parameters, ambient color parameters, or humidity change rate parameters.

The environmental information may include comprehensive information obtained through analyzing and processing the sensing parameters that describes the environmental status of the electronic device, which may include, but is not limit to, one or more of temperature, humidity level, air pressure, lighting conditions, UV index, noise level, air quality level, carbon dioxide concentration level, types and concentrations of harmful gases, magnetic field distribution, vibration environment, motion trajectory, vibration intensity, distance information, obstacle detection information, ambient brightness changes, ambient color information, geographical location, weather conditions (e.g., sunny, rainy, snowy), or time conditions (e.g., day or night).

In some other embodiments, the environmental information may be obtained not only through sensor collection but also through other means, including but not limited to: network data acquisition (obtaining publicly available environmental data such as weather forecasts and air quality indices via the internet), satellite remote sensing data (obtaining macro-environmental information such as geography and climate using satellite imagery or remote sensing technology), map service interfaces (obtaining terrain, location, and environmental data through Geographic Information System APIs), camera image analysis (analyzing captured environmental images using image processing techniques to extract information such as light, color, and obstacles), user settings (users manually setting specific states, such as power-saving mode, flight mode, and game mode), local storage data (retrieving historical environmental information from the device's storage), network device sharing (sharing environmental perception information, such as temperature or humidity readings from nearby devices, through connected smart devices), and simulation data generation (generating virtual environmental information through simulation systems for prediction or testing).

At S420, the one or more target prompts are determined based on the environmental information. According to the state, changes, or characteristics of the environment, the target prompts matching the current context may be automatically selected or generated to ensure that the output information generated by the target model conforms to a specific role, style, or requirement, thereby achieving more personalized and adaptive output.

For example, when the environmental information indicates poor air quality (such as a high PM2.5 index), the system may generate the target prompts to shift the target identity to “health expert,” constraining the target model to generate health-related prompts, such as wearing a mask or turning on an air purifier. As another example, when the environmental information indicates that the user is in a gym, the system may generate the target prompts to shift the target identity to “fitness expert,” constraining the model to generate fitness or exercise-related content, such as playing motivational music or suggesting exercise plans.

In the present embodiment, the environmental information may be collected and generated based on the sensor or other methods, allowing for real-time perception of changes in the external environment and the generation of prompts adapted to the scenario, improving accuracy and real-time performance, enhancing scenario adaptability, and improving user experience.

FIG. 5 is another flowchart of obtaining target prompts in the information generation method according to another embodiment of the present disclosure.

As shown in FIG. 5, in another embodiment, S120 may include S510-S520.

At S510, one or more sensing parameters are acquired via one or more sensors, where the one or more sensing parameters are used to characterize the status information of a user using an electronic device having the one or more sensors.

In this embodiment of the present disclosure, the sensing parameters may be acquired by sensors built into the electronic device, and/or by sensors capable of connecting and communicating with the electronic device, and/or by sensors in other electronic devices capable of connecting and communicating with the electronic device.

The sensors may include, but are not limited to, one or more of facial recognition sensors, voice recognition sensors, expression analysis sensors, heart rate sensors, electrodermal sensors, motion sensors, position sensors, GPS modules, pressure sensors, proximity sensors, light sensors, cameras, microphones, accelerometers, gyroscopes, biometric sensors, sleep monitoring sensors, electroencephalogram (EEG) sensors, body temperature sensors, gait analysis sensors, and environmental sound sensors.

The types of sensing parameters may include, but are not limited to: facial expression parameters, voice tone parameters, heart rate parameters, skin conductivity parameters, gait parameters, body temperature parameters, respiratory rate parameters, eye movement parameters, position parameters, activity level parameters, motion acceleration parameters, sleep quality parameters, pressure sensing parameters, touch pressure parameters, electroencephalogram (EEG) parameters, grip strength parameters, ambient sound parameters, focal length change parameters, posture parameters, or touch frequency parameters.

The status information may include comprehensive information obtained through analyzing and processing sensing parameters that reflect the user’s current situation or physiological, psychological, and behavioral characteristics. The status information may typically describe the user’s activity state, emotional state, identity characteristics, or interests and preferences. For example, the status information may include one or more of the user’s emotional state (e.g., happy, anxious, tired), current identity (e.g., father, employee, customer), current activity (e.g., running, sleeping, reading), attention level, topics of interest, geographical location (e.g., at home, at the office, outdoors), health status (e.g., normal heart rate, excessive stress), fatigue state, sleep state, postural state (e.g., standing, sitting, lying down), social interaction state (e.g., on a call, alone), intention state (e.g., learning intention, entertainment intention), language state (e.g., talking loudly, whispering), action state (e.g., moving quickly, standing still), workload state, and time-related state (e.g., work time, rest time).

In some other embodiments, the status information may be obtained not only through sensor collection but also through other means, including but not limited to: historical behavior analysis (inferring status, such as interests or needs, from user operation records), social network data (extracting content from social platforms, such as emotions or activity), third-party service interfaces (integrating data from external platforms, such as health or schedule information), collaborative device sharing (obtaining status from data shared from devices such as smartwatches), rule inference (inferring status based on preset rules, such as inferring fatigue from prolonged inactivity), machine learning model prediction (predicting status by combining models with data, such as emotion classification), or group behavior pattern comparison (inferring status by comparing with group behavior, such as inferring activity over a period of time).

At S520, the one or more target prompts are determined based on the status information. Based on the user’s current status information, the target prompts may be automatically generated to constrain or guide the target model’s processing, ensuring that the output information generated by the target model conforms to a specific role, style, or requirement, thereby achieving more personalized and adaptive output.

For example, when the status information indicates that the user is anxious, the target prompts “respond in a comforting tone” may be generated to guide the target model to output in a relaxed and comforting tone. As another example, when the status information indicates that the user is interested in technology, the system may generate the target prompts “provide technology-related content” or “answer questions in a popular science style.” As another example, when the status information indicates that the user is at home, the system may generate the prompt “provide family-related advice” or “interact in a relaxed tone.” As another example, when the status information indicates that the user’s attention is low, the system may generate the prompt “answer in a concise and easy-to-understand way” or “reduce the output of complex information.”

In the present disclosure, by collecting and generating the status information based on the sensors or other methods, the user’s status may be accurately identified, generating more personalized prompts and improving targeting and proactivity.

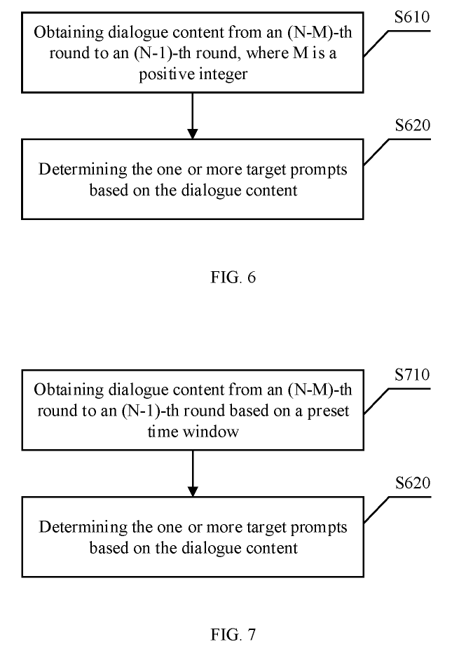

FIG. 6 is another flowchart of obtaining target prompts in the information generation method according to another embodiment of the present disclosure.

As shown in FIG. 6, in another embodiment, S120 may include S610-S620.

At S610, the dialogue content from an (N-M)-th round to an (N-1)-th round is obtained, where M is a positive integer and N is an integer larger than or equal to 2.

At S620, the one or more target prompts are determined based on the dialogue content.

The dialogue content from the N-th round (the latest round) of the current dialogue may be backtracked to extract the dialogue content from the previous M rounds, which is then processed as context information. N may represent the current round, i.e., the round in which the user is currently interacting. M may be a positive integer representing the number of rounds to backtrack. M=1 may mean backtracking only to the previous round of the dialogue. M>1 may mean backtracking for multiple rounds. The dialogue content from the (N-M)-th round to the (N-1)-th round may be extracted as the contextual dialogue content for the current dialogue situation, helping to generate the target prompts adapted to the current situation.

For example, consider the following multi-round dialogue between a user and a target model: Round 1: User input: “Check today’s weather for me.” target model output: “Today’s weather is sunny, temperature 20 degrees Celsius.” Round 2: User input: “What about tomorrow?” target model output: “Tomorrow will be cloudy, temperature 18 degrees Celsius.” Round 3: User input: “Is tomorrow suitable for running?” target model output: “Tomorrow will have high humidity but low wind, suitable for running.” Round 4: User input: “Okay, set a running reminder for me.’ target model output: “Okay, I will set a running reminder for 7 AM tomorrow.”

Assuming we are currently in the 4th round of dialogue (i.e., N=4). When M=1, we need to extract the dialogue content from the (N-M=4-1=3)-rd round to the (N-1=4-1=3)-rd round; when M=2, then we need to extract the dialogue content from the (N-2)-th round to the (N-1)-th round, i.e., the dialogue content from the second round to the third round. With M=2, the model may use information such as “tomorrow’s weather” and “suitable for running” to generate a more appropriate target prompt, such as “pay attention to running conditions and weather forecast,” thereby providing users with a more personalized service in the fourth round of the dialogue.

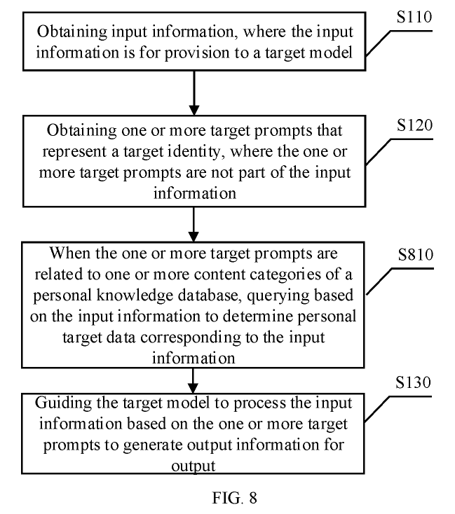

FIG. 7 schematically illustrates a flowchart of obtaining the dialogue content in the information generation method according to an embodiment of the present disclosure.

As shown in FIG. 7, in one embodiment, S610 may include:

S710, obtaining the dialogue content from the (N-M)-th round to the (N-1)-th round based on a preset time window. The width of the time window may be a preset time width, the end of the time window may be the time corresponding to the (N-1)-th round of the dialogue, and the times corresponding to the (N-M)-th round to the (N-1)-th round may be within the time window.

The preset time window, with a width equal to the preset time width, may be used to define the historical time range that the target model needs to reference. The width of the time window may be flexibly adjusted according to specific application scenarios, such as adapting to short-term rapid interactions or long-term complex interactions. The end of the time window may be fixed at the time corresponding to the (N-1)-th round of the current dialogue, meaning the time window covers the latest historical dialogue period. The range of the time window may be determined by the times corresponding to the dialogue content from the (N-M)-th round to the (N-1)-th round, where the (N-M)-th round is the starting point of the time window.

Based on the preset time window, the historical dialogue content within that window’s range may be obtained, including user input information and the target model’s output information. Dialogue content outside the time window may be ignored, ensuring the model only references the most recent relevant context information and avoiding interference from premature or irrelevant historical content.

In another embodiment, S610 may include obtaining the dialogue content from the (N-M)-th round to the (N-1)-th round based on a preset round window, where the width of the round window is M and the end of the round window is the (N-1)-th round. That is, a preset round window may be used to limit the range of historical rounds the target model needs to reference. Based on the preset round window, historical dialogue content within that window’s range may be obtained, including user input information and the target model’s output information, and dialogue content outside the round window may be ignored. The historical dialogue content within the window range may be fed into the classification model to obtain classification information, which is used to represent prompts indicating the target identity. In this implementation, the classification model may be a pre-trained intent understanding model, which obtains the user’s intent through analysis of contextual information. For example, within the given window, the user may be trying to guide the target model to answer with a specific identity or background knowledge. That is, the classification model may process the historical dialogue content within the window to obtain classification information. This classification information may be used to represent the target model’s identity prompts, ensuring that the target model is able to answer the next round of questions based on the corresponding identity knowledge, and ensuring that the answer is more focused and closer to the user’s desired answer.

In some embodiments, the target data may include one or more of the sensing parameters and/or environmental information represented by the sensing parameters, the user status information represented by the sensing parameters and/or the sensing parameters, or the dialogue content from the (N-M)-th round to the (N-1)-th round.

Generating the target prompts by processing the target data through the classification model may be achieved by processing one or more of the sensing parameters and/or environmental information represented by the sensing parameters, the user status information represented by the sensing parameters, or the dialogue content from the (N-M)-th round to the (N-1)-th round, to obtain different category labels. Different category labels may correspond to different target identities, output methods, or ranges, thereby generating at least one target prompt based on the category labels.

As another example, the classification model may be used to process one or more of the sensing parameters or the dialogue content from the (N-M)-th round to the (N-1)-th round, to obtain the environmental information corresponding to the electronic device and/or the status information representing the user. Then, another classification model may process the environmental information and/or the status information to obtain the target prompts.

In some embodiments, when the sensors are used to collect the sensing parameters and obtain the environmental information and/or the status information, the target prompts may be generated in each round. That is, whenever the target model receives input information for a new round, the sensing parameters collected by the sensors may be acquired to obtain the environmental information and/or the status information, and then the target prompts may be generated based on the environmental information and/or the status information.

In some other embodiments, when the sensors are used to collect the sensing parameters to obtain the environmental information and/or the status information, the target prompts may not be generated in every round, but rather only when certain triggering conditions are met. For example, the generation of the target prompts may be triggered when the sensing parameters collected by the sensors meet preset sensing parameter conditions.

For example, when the data of the location sensor indicates that the device is in a restaurant, the generation of the target prompts may be triggered, changing the target identity to “food expert” to guide the model in generating output. When the data of the facial data sensor indicates that the user’s emotion is low, the generation of the target prompts may be triggered, changing the target identity to “optimistic and positive” to guide the model in generating output.

In some embodiments, when the target prompts are determined through the dialogue content, the target prompts may be generated in each round. That is, whenever the target model receives input information for a new round, the dialogue content from the (N-M)-th round to the (N-1)-th round may be obtained and the target prompts may be generated.

In some other embodiments, when the target prompts are determined through the dialogue content, the target prompts may not be generated in each round, but rather only when certain triggering conditions are met. For example, when the topic of the user’s dialogue changes, the generation of the target prompts may be triggered, changing the target identity to correspond to the changed topic. As another example, when the tone or emotion expressed in the user’s dialogue changes, the generation of the target prompts may be triggered, changing the target identity to correspond to the changed tone or emotion.

In some other embodiments, data representing the environmental and/or status information may be collected simultaneously through the sensors and/or other methods mentioned above, along with the dialogue content from the (N-M)-th round to the (N-1)-th round. The target prompts may be generated by combining the environmental and/or status information and/or dialogue content. Alternatively, at least one target prompt may be determined by simultaneously collecting data representing the environmental and/or status information through sensors and/or other methods mentioned above, along with the dialogue content from the (N-M)-th round to the (N-1)-th round. Multiple target prompts may then be filtered, or multiple target prompts may be used interchangeably. The target prompts may be generated once per round, or generation may be triggered when at least a portion of the target data meets preset data conditions.

In one embodiment shown in FIG. 8, which is another flowchart of the information generation method, before S310, the method may further include:

S810, when the one or more target prompts are related to one or more content categories of a personal knowledge database, querying based on the input information, to determine personal target data corresponding to the input information.

A personal knowledge database may be a database specifically storing user personal information, preferences, historical behavior, or other related data. This data may be typically provided by the user in daily life or accumulated by the system through interaction with the user, providing the user with more personalized and customized services. Unlike public databases or general data sources, the personal database may focus on containing data highly relevant to the user’s identity, habits, interests, work content, etc.

For example, somebody’s work knowledge database may include his task list, meeting minutes, project progress, colleague contact information, etc. In a life scenario, a personal database may include the user’s schedule, shopping history, health records (such as steps, heart rate, etc.), or hobbies (such as favorite movie or music genres). When the user uses a smart assistant device, the personal database may also include environmental information collected by the device, the user’s frequently used phrases, historical search records, etc. This information may help the system generate more tailored suggestions or services based on the user’s specific needs in different scenarios, thereby improving user experience and interaction efficiency.

For example, first, whether the target prompts are related to the content categories of the personal knowledge database may be determined. When the target prompts match the content in the personal knowledge database, the system may further process the input information based on this match. When the target prompts are related to the content categories of the personal knowledge database, the system may query the personal knowledge database based on the input information to determine the personal target data corresponding to the input information. For example, in a work scenario, the target prompts may guide the system to query the user’s personal work knowledge database to obtain data related to the user’s current task. In a life scenario, the target prompts may guide the system to query the user’s schedule, interests, or other life-related data.

Correspondingly, S130 may include: using the one or more target prompts to guide the target model to process the personal target data and generate the output information for output. After retrieving the relevant personal target data, the system may guide the target model to process this data based on the target prompts to generate the output information that meets the user’s needs. For example, when the target prompts are work-related, the system may guide the target model to generate relevant work suggestions or schedules based on work task data. When the target prompts are relevant to the user’s personal interests, the system may guide the target model to generate personalized recommendations.

In the present disclosure, on the one hand, by integrating data from the personal knowledge database, the system may be able to quickly retrieve relevant information in multiple scenarios, reducing reliance on public databases and accelerating response speed. On the other hand, dynamic switching between different scenarios may be achieved, generating more personalized output information based on the user’s current scenario and needs through the personal database, thereby improving the user experience.

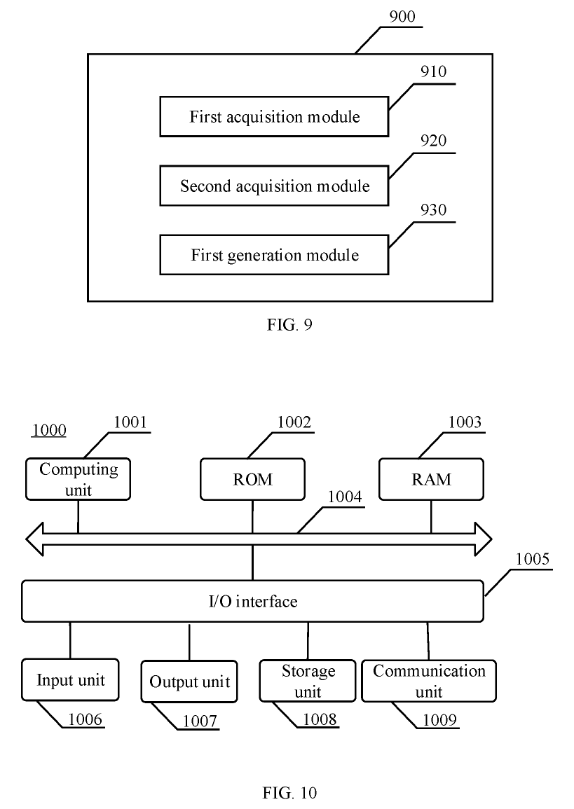

The present disclosure also provides an information generation apparatus. FIG. 9 is a schematically structural diagram of an information generation apparatus according to an embodiment of the present disclosure. As shown in FIG. 9, in one embodiment, the information generation apparatus 900 includes a first acquisition module 910, a second acquisition module 920, and a first generation module 930.

The first acquisition module 910 may be configured to obtain input information, which is for provision to a target model. In some embodiments, the first acquisition module 910 may be used to implement S110 in the aforementioned method, which will not be described in detail here.

The second acquisition module 920 may be configured to obtain target prompts that characterize the target identity. The target prompts may not be part of the input information, and may be used to guide the processing of the target model. In some embodiments, the second acquisition module 920 may be used to implement S120 in the aforementioned method, which will not be described in detail here.

The first generation module 930 may be configured to guide the target model to process the input information based on the target prompts to generate output information for output. In some embodiments, the first generation module 930 may be used to implement S130 in the aforementioned method, which will not be described in detail here.

Any one or more of the modules, submodules, units, and subunits according to embodiments of the present disclosure, or at least part of the functions of any one or more of them, can be implemented in a single module. Any one or more of the modules, submodules, units, and subunits according to embodiments of the present disclosure can be implemented by dividing them into multiple modules. Any one or more of the modules, submodules, units, and subunits according to embodiments of the present disclosure can be at least partially implemented as hardware circuitry, such as a Field-Programmable Gate Array (FPGA), a Programmable Logic Array (PLA), a System-on-Chip, a System-on-a-Substrate, a System-on-Package, or an Application-Specific Integrated Circuit (ASIC), or may be implemented in hardware or firmware by any other reasonable means of integrating or packaging circuitry, or implemented in software, hardware, or firmware, or in any suitable combination of any of these implementation methods. Alternatively, one or more of the modules, submodules, units, and subunits according to embodiments of the present disclosure can be at least partially implemented as computer program modules, which, when run, can perform corresponding functions.

For example, any one or more of the first acquisition module 910, the second acquisition module 920, and the first generation module 930 can be combined into one module/unit/subunit, or any one of these modules/units/subunits can be split into multiple modules/units/subunits. Alternatively, at least part of the functionality of one or more of these modules/units/subunits can be combined with at least part of the functionality of other modules/units/subunits and implemented in one module/unit/subunit. According to embodiments of the present disclosure, at least one of the first acquisition module 910, the second acquisition module 920, and the first generation module 930 can be at least partially implemented as hardware circuitry, such as a field-programmable gate array (FPGA), a programmable logic array (PLA), a system-on-a-chip, a system-on-a-substrate, a system-on-package, an application-specific integrated circuit (ASIC), or any other reasonable means of integrating or packaging circuitry, or implemented in software, hardware, or firmware, or in any suitable combination of any of these three implementation methods. Alternatively, at least one of the first acquisition module 910, the second acquisition module 920, and the first generation module 930 may be implemented at least partially as a computer program module, which can perform corresponding functions when the computer program module is run.

In the embodiments of the present disclosure, the information generation apparatus may correspond to the information generation method. For details of the information generation apparatus, references may be made to the previous description of the information generation method, and will not be repeated here.

The present disclosure also provides an electronic device. FIG. 10 is a schematically structural diagram of an electronic device suitable for implementing any information generation method provided by various embodiments of the present disclosure. The electronic device shown in FIG. 10 is merely an example used to illustrate the present disclosure, and does not limit the functionality and scope of the embodiments of the present disclosure.

As shown in FIG, 10, in one embodiment, the electronic device 1000 includes a processor 1001, which is able to perform various appropriate actions and processes according to a program stored in a read-only memory (ROM) 1002 or a program loaded from a storage portion 1008 into a random access memory (RAM) 1003. The processor 1001 may include, for example, a general-purpose microprocessor (e.g., a CPU), an instruction set processor, an associated chipset, or a special-purpose microprocessor (e.g., an application-specific integrated circuit (ASIC)), etc. The processor 1001 may also include an onboard memory for caching purposes. The processor 1001 may include a single processing unit or multiple processing units for performing different actions of the method flow according to various embodiments of the present disclosure.

The RAM 1003 may be configured to store various programs or data required for the operation of the electronic device 1000. The processor 1001, the ROM 1002, and the RAM 1003 may be interconnected via bus 1004. The processor 1001 may perform various operations of the method flow according to various embodiments of the present disclosure, by executing programs in the ROM 1002 and/or the RAM 1003. It should be noted that the programs may also be stored in one or more other memories other than the ROM 1002 and the RAM 1003. The processor 1001 may also perform various operations of the method flow according to various embodiments of the present disclosure by executing programs stored in said one or more other memories.

The electronic device 1000 may further include an input/output (I/O) interface 1005, which is also connected to the bus 1004. The electronic device 1000 may also include one or more of an input unit 1006, an output unit 1007, a storage unit 1008, or a communication unit 1009, connected to the input/output (I/O) interface 1005. The input unit 1006 may include input devices such as a keyboard, mouse, microphone, camera, etc., for receiving user input information. The input unit may also include sensors such as temperature sensors, humidity sensors, pressure sensors, accelerometer sensors, gyroscope sensors, light sensors, gas sensors, sound sensors, heart rate sensors, skin conductance sensors, touch sensors, infrared sensors, magnetometer sensors, position sensors, barcode scanners, biometric sensors, motion sensors, ambient noise sensors, air quality sensors, barometric pressure sensors, radar sensors, vibration sensors, rotation sensors, thermocouple sensors, ultraviolet sensors, current sensors, ultrasonic sensors, chemical sensors, facial recognition sensors, voice recognition sensors, expression analysis sensors, heart rate sensors, skin conductance sensors, motion sensors, position sensors, GPS modules, pressure sensors, proximity sensors, light sensors, cameras, microphones, accelerometers, gyroscopes, biometric sensors, sleep monitoring sensors, electroencephalogram (EEG) sensors, body temperature sensors, gait analysis sensors, or ambient sound sensors. The output unit 1007 may include devices such as cathode ray tubes (CRTs), liquid crystal displays (LCDs), and speakers. The storage unit 1008 may include devices such as hard disks. The communication unit 1009 may include network interface cards such as LAN cards and modems. The communication unit 1009 may perform communication processing via a network such as the Internet. A drive 1010 may also be connected to an input/output (I/O) interface 1005 as needed. A removable medium 1011, such as a magnetic disk, an optical disk, a magneto-optical disk, a semiconductor memory, etc., may be installed on the drive 1010 as needed so that computer programs read from it may be installed into the storage unit 1008 as needed.

The method according to various embodiments of the present disclosure may be implemented as a computer software program. The present disclosure may provide a computer program product including a computer program stored on a computer-readable storage medium. The computer program may include program code for performing the method provided by various embodiments of the present disclosure. In some embodiments, the computer program may be downloaded and installed from a network via the communication portion 1009, and/or installed from removable medium 1011. When the computer program is executed by the processor 1001, the computer program may lead the processor 1001 to implement the functions defined in the system of various embodiments of the present disclosure. According to embodiments of the present disclosure, the systems, devices, apparatuses, modules, units, etc., described above can be implemented by computer program modules.

The present disclosure also provides a computer-readable storage medium, which may be included in the device/apparatus/system described in the above embodiments; or it may exist independently and not be assembled into the device/apparatus/system. The aforementioned computer-readable storage medium may carry one or more programs, which, when executed, implement the method provided by various embodiments of the present disclosure.

The computer-readable storage medium may be a non-volatile computer-readable storage medium. Examples may include, but are not limited to: portable computer disks, hard disks, random access memory (RAM), read-only memory (ROM), erasable programmable read-only memory (EPROM or flash memory), portable compact disk read-only memory (CD-ROM), optical storage devices, magnetic storage devices, or any suitable combination thereof. The computer-readable storage medium may be any tangible medium that contains or stores a program that can be used by or in conjunction with an instruction execution system, apparatus, or device.

For example, the computer-readable storage medium may include the ROM 1002 and/or the RAM 1003 and/or one or more memories other than the ROM 1002 and the RAM 1003 described above.

The present disclosure also provides a computer program product including a computer program containing program code for performing the methods provided by various embodiments of the present disclosure. When the computer program product is run on an electronic device, the program code may be configured to cause the electronic device to implement the information generation methods provided by various embodiments of the present disclosure.

When the computer program is executed by the processor 1001, the processor 1001 may perform the functions defined in the system/apparatus provided by various embodiments of the present disclosure. The systems, devices, modules, units, etc., described above may be implemented using computer program modules.

In one embodiment, the computer program may rely on tangible storage media such as optical storage devices or magnetic storage devices. In another embodiment, the computer program may also be transmitted and distributed in the form of signals over a network medium, and downloaded and installed via the communication portion 1009, and/or installed from removable medium 1011. The program code included in the computer program may be transmitted using any suitable network medium, including but not limited to: wireless, wired, etc., or any suitable combination thereof.

The program code for executing the computer program provided by various embodiments of the present disclosure may be written using any combination of one or more programming languages. For example, the computational program may be implemented using high-level procedural and/or object-oriented programming languages, and/or assembly/machine languages. Programming languages include, but are not limited to, languages such as Java, C++, Python, C, or similar programming languages. The program code may be executed entirely on a user computing device, partially on a user device, partially on a remote computing device, or entirely on a remote computing device or server. In cases involving remote computing devices, the remote computing devices may be connected to user computing devices via any type of network, including local area networks (LANs) or wide area networks (WANs), or they can be connected to external computing devices (e.g., via the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in a flowchart or block diagram may represent a module, segment, or portion of code including one or more executable instructions for implementing a specified logical function. It should also be noted that in some alternative implementations, the functions indicated in the blocks may occur in a different order than indicated in the drawings. For example, two consecutively indicated blocks may actually be executed substantially in parallel, or they may sometimes be executed in reverse order, depending on the functions involved. It should also be noted that each block in a block diagram or flowchart, and combinations of blocks in a block diagram or flowchart, can be implemented using a dedicated hardware-based system that performs the specified function or operation, or using a combination of dedicated hardware and computer instructions. Those skilled in the art will understand that the features described in the various embodiments of the present disclosure can be combined and/or combined in various ways, even if such combinations or combinations are not explicitly described in the present disclosure. In particular, the features described in the various embodiments of the present disclosure can be combined and/or combined in various ways without departing from the spirit and scope of the present disclosure. All such combinations and/or combinations fall within the scope of the present disclosure.

The embodiments of the present disclosure have been described above. However, these embodiments are merely illustrative and not intended to limit the scope of the present disclosure. Although various embodiments have been described above, this does not mean that the measures in the various embodiments cannot be used advantageously in combination. Various substitutions and modifications can be made by those skilled in the art without departing from the scope of the present disclosure, and all such substitutions and modifications should fall within the scope of the present disclosure.

What is claimed is:

1. An information generation method comprising:
obtaining input information for provision to a target model;
obtaining a target prompt representing a target identity, the target prompt being not part of the input information and being used to guide processing of the target model; and
guiding the target model to process the input information based at least on the target prompt to generate output information.

2. The method according to claim 1, wherein:
the input information is input information of an N-th round in a dialogue based on the target model, N being an integer greater than or equal to 2; and
output information of an (N-1)-th round before the input information is generated by the target model based at least on a prompt representing an existing identity different from the target identity.

3. The method according to claim 2, wherein obtaining the target prompt includes:
obtaining dialogue content from an (N-M)-th round to an (N-1)-th round, M being a positive integer; and
determining the target prompt based at least on the dialogue content.

4. The method according to claim 3, wherein obtaining the dialogue content includes:
obtaining the dialogue content based on a time window, an end of the time window being a time corresponding to the (N-1)-th round, and time corresponding to the (N-M)-th round to the (N-1)-th round being within the time window.

5. The method according to claim 1, wherein obtaining the target prompt includes:
obtaining target data; and
processing the target data using a classification model to generate the target prompt.

6. The method according to claim 1, wherein obtaining the target prompt includes:
obtaining a sensing parameter through a sensor, the sensing parameter characterizing environmental information corresponding to an electronic device having the sensor; and
determining the target prompt based at least on the environmental information.

7. The method according to claim 1, wherein obtaining the target prompt includes:
obtaining a sensing parameter through a sensor, the sensing parameter characterizing status information of a user using an electronic device having the sensor; and
determining the target prompt based at least on the status information.

8. The method according to claim 1, further comprising, before guiding the target model to process the input information:
in response to the target prompt being related to a content category of a personal knowledge database, querying based on the input information to determine personal target data corresponding to the input information;
wherein guiding the target model to process the input information includes:
guiding the target model to process the personal target data based at least on the target prompt to generate the output information.

9. An electronic device comprising:
an input apparatus configured to receive input information for provision to a target model; and
a processor configured to:
obtain a target prompt representing a target identity, the target prompt being not part of the input information and being used to guide processing of the target model; and
guide the target model to process the input information based at least on the target prompt to generate output information.

10. The electronic device according to claim 9, further comprising:
a sensor configured to acquire a sensing parameter characterizing environmental information corresponding to the electronic device;
wherein the processor is further configured to, when obtaining the target prompt:
determine the target prompt based at least on the environmental information.

11. The electronic device according to claim 9, further comprising:
a sensor configured to acquire a sensing parameter characterizing status information of a user using the electronic device;
wherein the processor is further configured to, when obtaining the target prompt:
determine the target prompt based at least on the status information.

12. The electronic device according to claim 9, wherein:
the input information is input information of an N-th round in a dialogue based on the target model, N being an integer greater than or equal to 2; and
output information of an (N-1)-th round before the input information is generated by the target model based at least on a prompt representing an existing identity different from the target identity.

13. The electronic device according to claim 12, wherein the processor is further configured to, when obtaining the target prompt:
obtain dialogue content from an (N-M)-th round to an (N-1)-th round, M being a positive integer; and
determine the target prompt based at least on the dialogue content.

14. The electronic device according to claim 13, wherein the processor is further configured to, when obtaining the dialogue content:
obtain the dialogue content based on a time window, an end of the time window being a time corresponding to the (N-1)-th round, and time corresponding to the (N-M)-th round to the (N-1)-th round being within the time window.

15. The electronic device according to claim 9, wherein the processor is further configured to, when obtaining the target prompt includes:
obtain target data; and
process the target data using a classification model to generate the target prompt.

16. The electronic device according to claim 9, wherein the processor is further configured to:
before guiding the target model to process the input information, in response to the target prompt being related to a content category of a personal knowledge database, query based on the input information to determine personal target data corresponding to the input information; and
when guiding the target model to process the input information:
guide the target model to process the personal target data based at least on the target prompt to generate the output information.

17. A non-transitory computer-readable storage medium storing instructions that, when executed by a processor, cause an electronic device including the processor to:
obtain input information for provision to a target model;
obtain a target prompt representing a target identity, the target prompt being not part of the input information and being used to guide processing of the target model; and
guide the target model to process the input information based at least on the target prompt to generate output information.

18. The storage medium according to claim 17, wherein:
the input information is input information of an N-th round in a dialogue based on the target model, N being an integer greater than or equal to 2; and
output information of an (N-1)-th round before the input information is generated by the target model based at least on a prompt representing an existing identity different from the target identity.

19. The storage medium according to claim 18, wherein the instructions, when executed by the processor, further cause the electronic device to, when obtaining the target prompt:
obtain dialogue content from an (N-M)-th round to an (N-1)-th round, M being a positive integer; and
determine the target prompt based at least on the dialogue content.

20. The storage medium according to claim 19, wherein the instructions, when executed by the processor, further cause the electronic device to, when obtaining the dialogue content:
obtain the dialogue content based on a time window, an end of the time window being a time corresponding to the (N-1)-th round, and time corresponding to the (N-M)-th round to the (N-1)-th round being within the time window.
